(19) United States
(12) Patent Application Publication
(10) Pub. No.: US 2003/0220866 A1
(43) Pub. Date: Nov. 27, 2003

(54) System and method for pay for performand advertising in general media

(75) Inventors: Craig Allen Pisaris-Henderson, Fort Myers, FL (US); Anthony Albert Garcia, Fort Myers, FL (US); Phillip Ross Thune, Bonita Springs, FL (US); Jason Benhard Williams, Cape Coral, FL (US); David Clouston Rae, Naples, FL (US); Peter Thomas Neumann, Fort Myers, FL (US); Sean Patrick Hart, Cape Coral, FL (US); Robert Llewellyn Protheroe, Naples, FL (US)

Correspondence Address: BAKER & BOTTS, 30 ROCKEFELLER PLAZA, NEW YORK, NY, 10112

(73) Assignee: Findwhat.com, Fort Myers, FL

(21) Appl. No.: 10/331,926

(22) Filed: Dec. 30, 2002

Related U.S. Application Data
(60) Provisional application No. 60/344,100, filed on Dec. 28, 2001.

(51) Int. Cl. G06F 17/60

(52) U.S. Cl. 705/37; 705/14

(57) ABSTRACT

A method for providing advertising services in general media using a pay-for-performance model is provided. A service provider defines at least one biddable advertisement for presentation in advertising media. A bid amount chargeable to a participating advertiser upon a response to the at least one biddable advertisement is determined, generally by an open auction conducted by the service provider. The biddable advertisement is associated with a participating advertiser based, at least in part, on the bid amount. As responses to the biddable advertisement are received by the service provider, they are provided to the associated participating advertiser and that participating advertiser is charged the bid amount for the response. The advertiser associated with a biddable ad can change in real time based on the auction and association mechanisms used by the service provider, such as a bid weighted rotation which associates the biddable ad to a number of participating advertisers.

The present application claims the benefit of United States Provisional Patent Application entitled “SYSTEM AND METHOD FOR MARKETING IN GENERAL MEDIA EMPLOYING A PAY FOR PERFORMANCE HIERARCHY FOR ADVERTISEMENT PLACEMENT AND PERFORMANCE TRACKING” which was filed on Dec. 28, 2001 and assigned Serial No. 60/344,100.

### FIELD OF THE INVENTION

The present invention relates generally to marketing and advertising distribution and more particularly relates to systems and methods for pay for performance advertising in one or more types of general media based on an open bidding architecture and tracking consumer responses to same.

### BACKGROUND OF THE INVENTION

The Internet has quickly grown from an obscure resource for high level researchers to a ubiquitous resource having hundreds of millions of pages of content which is accessible by millions of users. In order to find desired content on the Internet, users generally employ one or more search engines which rely on a computer algorithm to determine the relevance of content to a particular inquiry. As an alternative to the computer generated relevancy measure which is provided by a number of conventional search engines, some search engines provide a pay for placement feature which effects where particular content will be listed in response to a user search. In this pay for placement model, advertisers pay a bid amount for certain keywords which are expected to be relevant to the goods and services offered on the content pages they provide. If a user's search includes a keyword which has been purchased by one or more advertisers, these content pages will be listed with a higher priority, in descending order, starting the highest bidding advertising. In a pay for placement model, advertisers pay the bid amount when a user clicks on the displayed content page listing, which provides a hypertext link to the advertisers content pages. The pay for placement model results in the generation of a database of advertisers which are willing to pay a certain denomination when a user actively clicks on a listing.

The pay for placement model has proven to be beneficial to both advertisers and consumers. Advertisers pay for results and consumers are presented with results of high relevance based on their interests. Similar benefits can be derived from a pay for performance system for distributing advertising content in general media, such as magazines, newspapers, television, radio and the like.

### OBJECTS AND SUMMARY OF THE INVENTION

It is an object of the present invention to provide a pay for placement bidding process, such as via the internet, where advertisers can engage in an auction for placement among a number of advertising placements which have been pre-purchased by a service provider in traditional media, such as a block of classified advertising placements grouped by keywords or other topics of interest.

It is a further object of the present invention to provide a pay for placement process for conventional media, wherein a service provider receives inquiries from consumers for all participating advertisers at one or more common hubs and reroutes the inquiries to the appropriate participating advertiser.

In accordance with the present invention, a method for providing advertising services in general media using a pay-for-performance model is provided. A service provider defines at least one biddable advertisement for presentation in advertising media. A bid amount chargeable to a participating advertiser upon a response to the at least one biddable advertisement is determined, such as by an open auction conducted by the service provider. The biddable advertisement is then associated with a participating advertiser based, at least in part, on the bid amount. As responses to the biddable advertisement are received by the service provider, the responses are provided to the associated participating advertiser and that participating advertiser is charged the bid amount for each response.

The advertiser associated with a biddable ad can change in real time based on the auction and association mechanism used by the service provider, such as a bid weighted rotation which associates the biddable ad to a number of participating advertisers.

In the present invention, a service provider functions as an intermediary between advertisers and advertising content providers, such as magazines, newspapers, television, radio and the like. The service provider also functions as an intermediary between consumers responding to advertising content and the participating advertisers.

The service provider can purchase blocks of advertising space from media providers and at least partially define one or more components of the advertising space, such as advertising placements therein, on which advertisers may bid. These biddable advertising components are referred to herein as biddable ads.

Also in accordance with the present methods, the service provider can outsource pay for performance services to one or more media providers. The outsourced media providers can be called media channels. In this case, the service provider does not typically purchase ad space from the media channel but provides the services to enable pay for performance advertising by the media provider within the media channel. The service provider facilitates bidding by advertisers for biddable ads and receives bids associated therewith. Consumer responses to biddable ads are received by the service provider and are then redirected to advertisers, or are provided with information content thereof, based on the advertiser bids. The service provider tracks consumer responses and charges or debits advertiser accounts associated with the responses.

Biddable ads may be fully defined by the service provider and/or media provider. In certain dynamic or interactive media, the biddable ads may include content specified by the participating advertisers. Content from advertisers can be maintained by the service provider and integrated with predefined content to fully define the biddable ads.

Various mechanisms to track consumer responses can be employed. For example, in one embodiment the service provider hosts a number of telephone lines, such as 800 and 877 toll free numbers. The biddable ads are then associated with service provider telephone lines through phone numbers included in the advertisements. Consumer responses are tracked as calls are made to the service provider phone numbers. Consumer calls are routed or forwarded to a phone number provided by the associated advertiser and the associated advertiser account is debited by the bid amount.

Similarly, each biddable ad can include an Internet web page address, provided by the service provider, and traffic to the specified web page address can be tracked by the service provider as responses to the associated biddable ad. Such consumer tracking methods are particularly useful in static advertising media such as newsprint, magazines, conventional billboards and the like, where interactive functionality is not possible.

In interactive media, such as kiosks, consumers can interact with the service provider and, for example, select a specific biddable ad to learn more about products or services offered by the advertiser or have a discount coupon printed. The consumer's interactive selection of the biddable ad, the delivery of additional advertiser content or the printing of a coupon can serve as tracking mechanisms.

Preferably advertiser listings and biddable ads have content descriptors associated therewith. Content descriptors or category descriptors enables media channels to specify criteria for advertising content associated with biddable ads and for listings to be screened and matched based thereon. This can be useful in organizing ads by type of content and in targeting, or restricting ads, by anticipated viewing audiences. Content descriptors can also be useful in allowing users of interactive media platforms to search for biddable ads of interest, or for media channels to present biddable ads which are relevant and in response to user actions and display screens.

In the present methods, the association of an advertiser to a biddable ad is preferably based on the bid amounts offered by the advertisers in order to receive the consumer responses to the advertisement. The association can be a simple “winner takes all” assignment based on the highest bid placed thereon or by a rotation of at least a portion of the bidding advertisers for the biddable ad. Alternatively, in a system of advertiser rotation, the rotation of advertisers can be weighted based on bids such that the level of advertiser participation in consumer responses to the ad and/or ad presentation is associated to the bid amount for the advertiser.

A so called “Dutch auction” can also be employed to establish an advertiser rotation. In such a case, a predetermined number of advertisers will be allowed in the rotation and each will pay an amount for responses based on the bid amount of the last advertiser allowed in the rotation.

A group of biddable ads can be defined in an advertising space by the service provider wherein a plurality of placements have a value order, such as advertisements arranged down a column, and the placements are associated with a corresponding number of advertisers based on descending bid amounts. The association of advertisers to the ordered placements is in order of the highest to lowest bidding advertiser.

### BRIEF DESCRIPTION OF THE DRAWINGS

FIG. 1 is a simplified block diagram of a system for practicing the present method of pay for performance advertising in general media.

FIG. 2A is a pictorial diagram illustrating an example of a fully defined biddable ad relating to the descriptor CAR SALES.

FIG. 2B is a pictorial diagram illustrating an example of a biddable ad which allows for the inclusion of advertiser content.

FIG. 3 is a pictorial diagram illustrating an exemplary group of biddable ads wherein five possible advertising positions are available.

FIG. 4A is a table depicting an exemplary biddable ad bid profile for a group of advertisers.

FIG. 4B is a table showing the results of a set of eight advertiser measured rotations for the bid profile of FIG. 4A.

FIG. 4C is a pictorial diagram illustrating a range assignment for the bid profile of FIG. 4A for use in a random rotation of advertisers in accordance with the bid profile of FIG. 4A.

FIG. 5 is a simplified block diagram depicting a database table structure in accordance with the present invention.

FIG. 6 is a pictorial diagram illustrating an exemplary bid management graphical user interface screen for use by advertisers to manage bids associated with listings and biddable ads.

FIG. 7 is a flow diagram depicting the transaction flow for a consumer response to a static biddable ad.

FIG. 8 is a flow diagram depicting the transaction flow for a consumer response to a dynamic biddable ad.

FIG. 9 is a flow diagram depicting the transaction flow for a consumer response to an interactive biddable ad.

### DETAILED DESCRIPTION OF PREFERRED EMBODIMENTS

The present invention provides systems and methods for pay for performance advertising in general media and can be practiced with support for one or more forms of general media. As used herein, the term pay for performance advertising refers to advertising placements wherein an advertiser pays a service provider based on measured responsiveness to an advertisement as opposed to payment based primarily on the expected number advertising impressions. The price the advertiser pays the service provider is generally determined by an open auction system whereby a number of advertisers competitively bid for advertising placement. Such advertising placements are referred to herein as biddable ads.

Systems and methods are provided to distribute biddable ads in such a way that responses can be routed to a participating advertiser and the performance of the ads can be measured. A service provider obtains advertising space in general media, such as periodicals, newspapers, television, radio and the like. The service provider will, at least in part, define advertising placements that will be placed in the advertising space. Advertisers interested in receiving responses to the advertising placements will engage in an auction and will competitively bid to receive the responses. The auction generally takes place via the Internet and is hosted by the service provider. Advertisers are then associated with ads, i.e., the advertiser will receive responses, based on their bids placed thereon. The service provider receives consumer responses to the biddable ads, tracks the consumer responses and routes the consumer responses to the associated participating advertiser. The service provider charges or debits the account of the associated advertiser based on the advertiser's bid amount for each response received.

In the context of the present invention, general media can be classified into three categories: static, dynamic and interactive. Generally, static media is media in which ads do not change over reasonably extended time periods. Numerous examples of static media are found in printed media such as newspapers, magazines, catalogs, flyers, mailers, posters, conventional billboards and the like. This form of media is static in that between publication cycles, the placement and content of the advertisements are fixed. Dynamic media is media in which ads can be changed in real time or quasi-real time, such as electronic billboards which have images that can be updated or changed, or broadcast media which can receive ad programming. Interactive media is media which is dynamic and has the ability to receive consumer input and can be updated or changed in response to the consumer input. Examples of interactive media can include Internet websites or kiosks having a user interface, such as a touch screen, whereby, for example, a consumer can select an ad to learn more about the products or service described therein. Video on demand systems which provide for user input to select and initiate specific video programs can also be used as a source of interactive media.

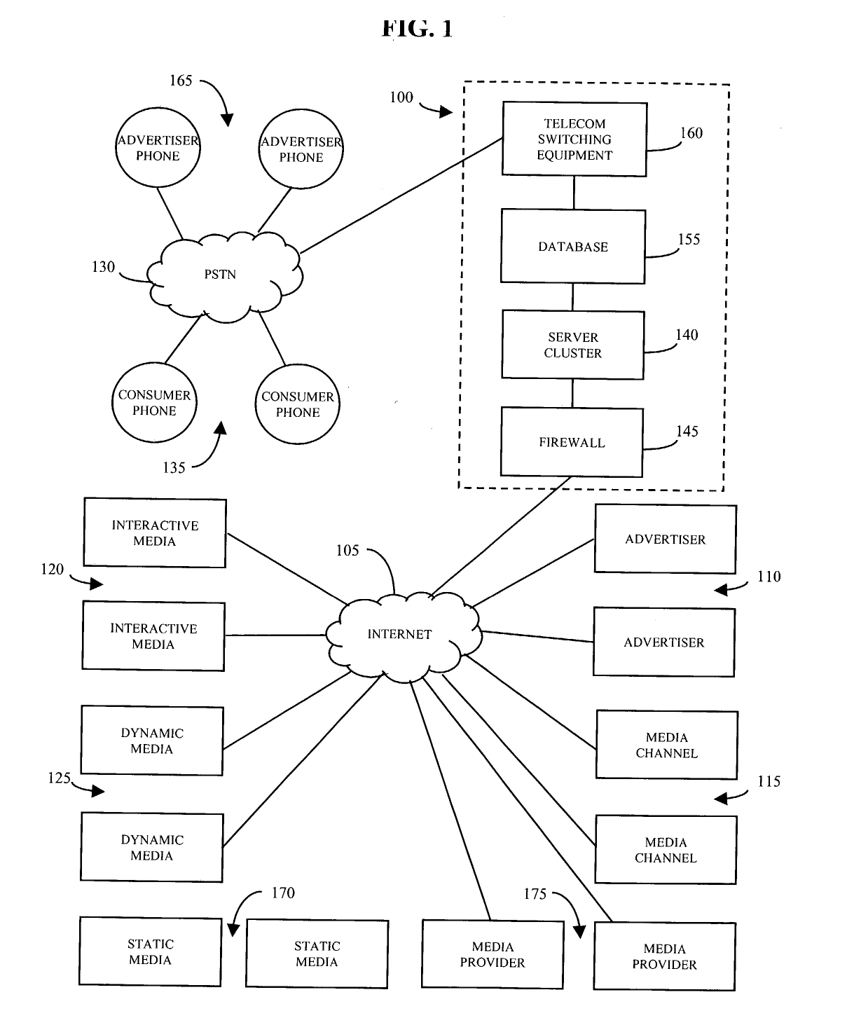

FIG. 1 is a simplified block diagram of a system for practicing the present methods of pay for performance advertising in general media. The system includes a system provider 100 which is connected to a data network 105, such as the Internet. Advertisers 110 are connected to system provider 100 via the data network 105 and manage accounts, ad listings and bids for biddable ads maintained by the service provider 100. Media distribution channels 115, media providers 175, interactive media systems 120 and dynamic media systems 125 are connected to the Internet 105 to facilitate management and delivery of biddable ads.

In addition to interactive media systems 120 and dynamic media systems 125, the pay for performance system can also take advantage of static media 170, in which the service provider obtains advertising space.

Service provider 100 is also connected to a public switched telephone network 130. Also connected to the telephone network 130 are consumer phones 135 and advertiser phones 165. Service provider 100 includes a server cluster 140, which can include one or more servers, and is coupled to the Internet 105 preferably through a conventional firewall 145 for security purposes. Server cluster 140 is also connected to a database 155. Database 155 is operably connected to telecom switching equipment 160.

FIG. 1 also includes media channels 115. Services provided by the service provider can be outsourced to third party service providers, such as media providers who wish to offer such services to their advertisers. The system can be private labeled by the service provider and offered to such third parties. In such cases, the third parties arrange for the advertising space and the service provider offers features such as hosting the auction service and response tracking to the third parties in a manner which is transparent to the participating advertisers and consumers. Outsourced service providers are referred to herein as media channels 115. In this case, the service provider 100 does not typically purchase ad space from the media channel 115 but provides the services, in a “private label” manner, to enable pay for performance advertising within the media channel 115. To the consumer, the service appears to be operated by the media channel 115. However, the system and methods performed by the system are provided and maintained by the service provider 100.

In the present invention, service provider 100 functions as an intermediary between advertisers 110 and media providers 175 and media channels 115. The service provider 100 also functions as an intermediary between consumers responding to advertising placements and the participating advertisers 110. Consumers can respond to advertising placements via phones 135, internet website or through other interactive media 120.

The service provider purchases blocks of advertising space from media providers 170 and defines one or more components of the space, such as advertising placements, on which advertisers 110 may bid. For example, the service provider 100 may purchase a full page of advertising space in static media, such as a magazine, and partition the full page of advertising space into a number of advertising placements or components. The advertising placements are then offered to participating advertisers who bid against each other to receive responses to the advertising placements. These biddable advertising placements or components are referred to herein as biddable ads.

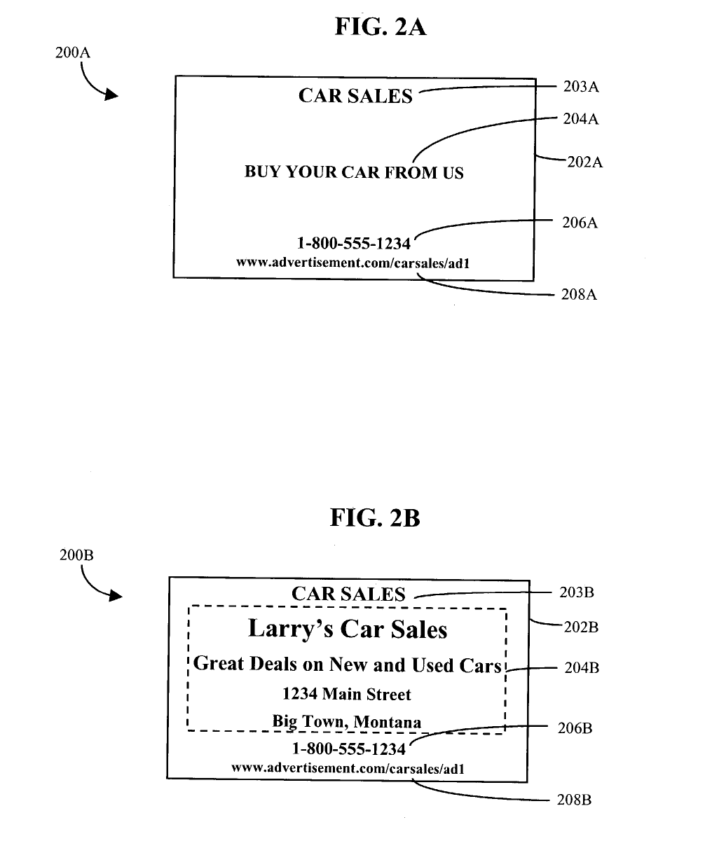

FIGS. 2A and 2B illustrate examples of biddable ads. An example of a fully defined biddable ad 200A relating to the descriptor CAR SALES is provided in FIG. 2A. Biddable ad 200A has an overall size defined by box 202A and includes a content descriptor 203 and fixed content 204A. Also included in biddable ad 200A is a phone number 206A which can be used for tracking consumer responses to the biddable ad 200A. The biddable advertisement 200A can also include a web page address 208A to provide for consumer response to the advertising placement via the internet. The web page address is generally directed to a web page of the service provider 100 and can either include additional content for an advertiser or can provide a redirection to an advertiser's website.

The service provider phone number 206A can be a unique phone number for each advertising placement or a single number applied to multiple biddable ads wherein the ads include the use of additional numerical codes to identify specific ads. The numerical code can appear as a phone extension in the billable ad and can be used to associate a number of advertising placements to a single service provider telephone line. The consumer can be voice prompted to enter an extension number by the telecom switch 160 for such service provider phone numbers.

Preferably ad listings and biddable ads can include content descriptors 203A. This enables the categorization or specification of advertising content applicable to biddable ads. The content descriptors are useful in organizing ads by type of content, or products and services, and in targeting or restricting ads by anticipated viewing audiences. Content descriptors 203A also facilitate a mechanism for advertisers to search for biddable ads on which they want to participate. Associated content descriptors 203A can also be useful in allowing users of interactive media platforms to search for biddable ads of interest, or for media providers to present biddable ads which are relevant to a given section of a publication.

In dynamic media, the content of the advertising placement can include advertiser specified content. An example of a biddable ad 200B which allows for the inclusion of advertiser content is depicted in FIG. 2B. Biddable ad 200B has an overall size defined by box 202B and can accommodate advertiser content of the size defined by box 204B. Also included in biddable ad 200B is a phone number 206B and or web page address 208B which is specified by the service provider and is used for receiving and tracking consumer responses to ad 200B. A content descriptor 203B can also be provided in the advertising placement.

For dynamic media, the advertiser specified content which is to be inserted in a dynamic advertising placement can be maintained by the service provider 100 in an advertiser account in the database 155 and integrated with predefined content from the service provider 100 to fully define the dynamic biddable ads.

The service provider 100 provides a system which supports an auction among participating advertisers and allows bidding by advertisers 110 for the biddable ads. A number of participating advertisers 110 access server 140 of the service provider 100 via the internet 105. The server 140 controls access to a database 155. Database 155 provides participating advertisers accounts and maintains a mapping of available biddable ads to the participating advertisers based on the current bid amounts.

Consumer responses to biddable ads are routed to advertisers 110 based on advertiser bids. The routing operation can include providing additional information on a web page provided by the service provider, offering additional information on a telephone response system offered by the service provider, or redirecting the response to a telephone number or web page of the advertiser. For example, a consumer responding to an ad by phone 135 can be automatically forwarded to a phone 165 of the associated advertiser by the service provider 100. A consumer responding to interactive media 120 can be provided with additional advertiser content. In all cases, the service provider 100 tracks consumer responses and debits advertiser accounts associated with the consumer responses.

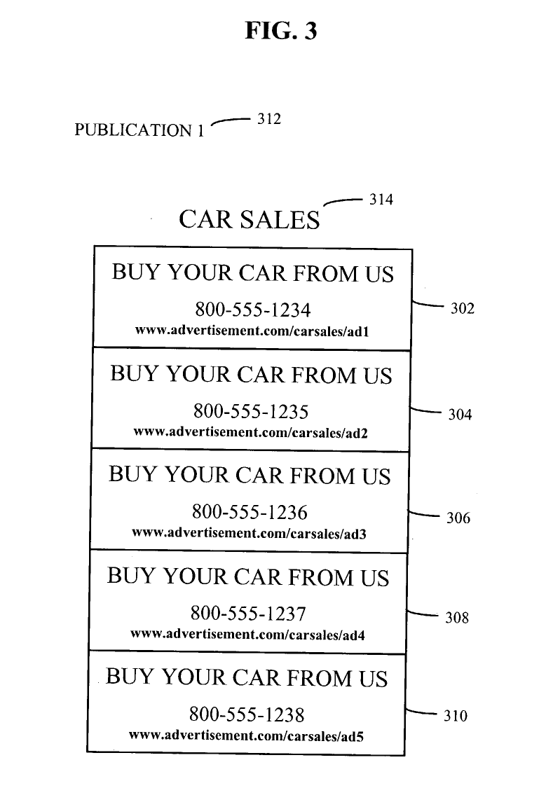

FIG. 3 is a pictorial representation of a block of advertising space organized as a group of biddable ads for a specific category of services. The biddable ad placements include five possible advertising positions for ads 302, 304, 306, 308 and 310 which are available in publication 1 (312) for an advertisement for the category CAR SALES 314. Each of the ads is associated with a specific telephone number which is directed to the telephone switching equipment of the service provider 100. Participating advertisers 110 can engage in an ongoing bidding process for the group biddable ad, such as takes place in connection with pay for placement advertising for search result listings on the internet, to determine which advertiser 110 will receive the traffic generated from consumers calling the respective numbers.

Owing to the concept of primacy, the biddable advertisements are assigned in order of descending bid amount assuming that the first listed placement is more valuable than the second, third, fourth placements, etc. For example, in FIG. 3, the highest bidder for the category of CAR SALES would receive the first placement 302 and would receive inquiries to the number 800-555-1234. The second highest bidder would be associated with the second ad placement 304, the next highest bidder would be associated with the third ad placement 306, the fourth highest bidder would be associated with the fourth ad placement 308 and the fifth highest bidder would be associated with the fifth ad placement 310.

When a consumer responds to the biddable ad 302 by dialing the number 800-555-1234, the service provider would receive the call via the PSTN 130 and automatically redirect the incoming call to a telephone number of the highest bidder which is maintained in database 155. The service provider 100 records the call event and debits the highest bidders account for the bid amount for each call received and redirected. If a different participating advertiser 110 subsequently presents a higher bid for this first listed advertising placement, the new high bidding participating advertiser 110 will receive the inquiries directed to the first listed number. The second highest bidding advertiser would receive second placement 304 and receive inquiries directed to the number 800-555-1235. The auction process preferably takes place in real time. Therefore, while the advertising placement is fixed in static media, the recipient of the responses to advertising placements may change frequently based on the level of bidding activity.

Alternatively, a “Dutch auction” can be used to fill the advertising placements in FIG. 3. In this case, the top five bidding advertisers would be selected for the five available ad placements and would each pay an amount for responses equal to the fifth highest bidders bid amount. The order of advertiser association with the placements can be based on random selection or rotation of the selected advertisers among the five placement positions.

The advertising placements include information specified by the service provider 100 which enables the service provider to track consumer responses to the advertising placements. As illustrated in FIGS. 2A and 2B, the service provider 100 can acquire a number of telephone lines, such as 800 and 877 toll free numbers. Consumer responses can be tracked as calls are made to the service provider phone numbers and received by telecom switch 160.

A consumer responding to the advertising placement dials the number listed in the ad from a consumer phone 135. The call is directed through the PSTN 130 to the telecom switching equipment 160 and can be forwarded to the associated advertiser phone 165 by the telecom switching equipment 160. The advertiser phone number is associated with the biddable ad based on advertiser bids and is contained in a routing table located in the database 155 which can be accessed by telecom switch 160. The response is recorded in the associated advertiser account by debiting the account for the advertiser's bid amount. This consumer response tracking method is particularly useful in static advertising media 170 such as newspapers, magazines, conventional billboards and the like, where interactive functionality is not available for response tracking.

Also illustrated in FIGS. 2A and 2B, advertising placements can include web page addresses 208A and 208B which can be directed to web pages hosted by the server cluster 140. A consumer response to the web page listed in the advertisement can be redirected by the server cluster 140 to a web page specified in the advertiser account in database 155.

Alternatively, in interactive media 120, such as kiosks, consumers can select a specific biddable ad to learn more about products or services offered by the associated advertiser 110 or to have an associated discount coupon printed. The consumer's interactive selection, the delivery of additional advertiser content or the printing of a coupon can serve as tracking mechanisms.

Participating advertisers 110 maintain accounts in database 155 in which advertisers submit ad listings to the service provider 100 for participation in biddable ads. The ad listings can include a phone number and/or web page for forwarding consumer responses, advertising content for inclusion in a dynamic biddable ad, and additional associated advertising content for presentation to a consumer interactively responding to a biddable ad. The advertiser accounts also include accounts for tracking consumer responses to advertising placements associated with the advertiser as well as for tracking payment totals due to the service provider for such responses.

Generally, the number of biddable ad placements is finite, and preferably, is less than the number of advertisers interested in participating in such placements. Therefore, mechanisms for determining the selection and order of advertiser participation is an aspect of the present systems and methods.

In general, advertisers 110 are selected for association to a biddable ad based on bid amounts for the respective ad. In one selection method, the highest bidding advertiser is always associated with the particular biddable ad. In another method, a group of biddable ads can be defined in the biddable space, wherein a number of placements are defined which have a hierarchical order of value. In this case, the association of advertisers 110 to the ordered placements is in order of the highest to lowest bidding advertiser.

In yet another method of associating advertisers with biddable ads, a bid-weighted rotation can be used to allow a single advertising placement to be used by multiple bidding advertisers. In this case, the advertisement is time shared by advertisers and the frequency of impressions or responses associated with the different participating advertisers is based on the respective bid amounts. The rotation is based on the bid amounts of the participating advertisers whereby the higher the bid amount, the higher the level of participation.

A method of rotation based on the bid amounts can be called a bid-weighted rotation. The bid weighted rotation can be determined based on historical rotation data in addition to the bid profile (bid weighted measured rotation) or it can be determined as a random event in conjunction with the bid profile (bid weighted random rotation). When a current rotation expires, a next advertiser rotation is determined. Alternatively, the next rotation can be determined prior to the expiration of the current rotation. For example a schedule can be calculated for a predetermined number of rotations, i.e., the next 100 rotations, based on the current bid profile for the ad. However, since bidding can be performed in real time, such prior determination can be rendered inaccurate due to bid changes. It therefore may be preferable to make the determination upon expiration of the current rotation.

Expiration of a rotation can be time based or response or selection based. For biddable ads that include advertiser specific content, time based expiration is preferred in that the included advertiser content provides for participation as a function of time. For biddable ads that are fully defined by the service provider 100 and have no advertiser specific content, response and selection based expiration is preferred since this is the most accurate measurement of participation in such ads. Depending on the length of time a biddable ad will run and the expected rate of rotation, the number of participating advertisers may have to be limited during each rotation.

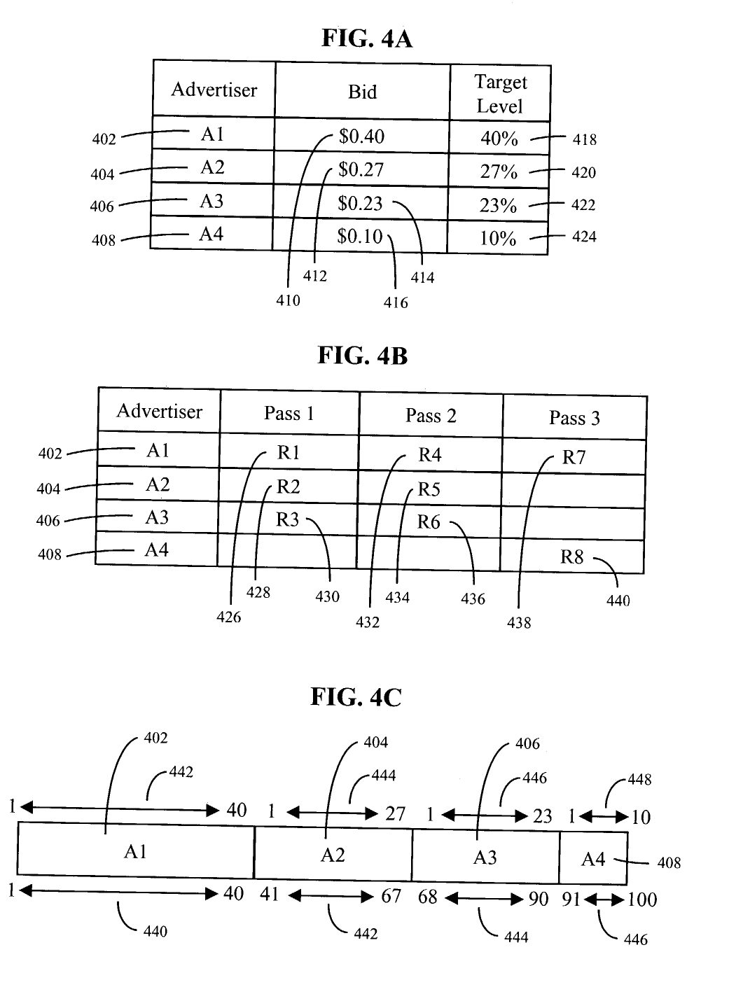

FIG. 4A depicts an exemplary biddable ad bid profile for advertisers 402, 404, 406 and 408 each having a bid amount respectively being 410, 412, 414 and 416. A target percentage level of participation for each advertiser is determined which is equal to the advertiser's bid amount divided by the total of the bid amounts for all participating advertisers, multiplied by 100 percentage units. In this example, the total of the bids is equal to $1.00. As such there is a simple correlation between the bid amounts and the target participation levels. Advertisers 402, 404, 406 and 408 have target participation levels 418, 420, 422 and 424 respectively.

Rotation among the participating advertisers can be based on a measurement of past participation within a rotation. For a measured rotation, a count of the number of times each advertiser has been in rotation is maintained by the service provider 100. The total count for the number of times all advertisers have been in rotation can be maintained or calculated as needed by summing the individual counts. Each time a current rotation expires, the server 100 determines if one or more advertiser target participation levels have been met by their actual participation levels as indicated by the counts. The participation levels are examined and satisfied in the order starting from the advertiser having the highest target level and going to the lowest target level. This ordering provides priority to the advertisers in the rotation based on participation level. When two or more advertisers have the same bid amount the order can reflect the length of time each advertiser has maintained their current bid whereby the advertiser having the longest bid duration is examined first.

FIG. 4B is a table which illustrates the results of a set of eight rotations 426, 428, 430, 432, 434, 436, 438, and 440, for the bid profile shown in FIG. 4A. Prior to the first rotation 426, no advertisers have yet been in rotation. As such, the target level of the highest bidding advertiser 402 (40%), has not yet been met and the first rotation 426 is assigned to advertiser Al. For the second rotation 428, the participation levels, actual and target, of the highest bidding advertiser 402 are first measured. Advertiser 402 has a count of one placement out of a total count of one placement and therefore has an actual level of 100% which satisfies the associated target level 418 of 40%. The participation levels of the next highest bidding advertiser 404 are then examined. Since advertiser 404 has not been presented, this advertiser has a participation level of 0% against a target level 420 of 27%. The second rotation 428 is therefore assigned to advertiser 404.

For the third rotation 430, the participation levels of the highest bidding advertiser are first examined and found to be an actual of 50% against a target 418 of 40%. The levels of the next highest bidding advertiser 404 are then examined and found to be an actual of 50% against a target 420 of 27%. The levels of the next highest bidding advertiser 406 are then examined and determined to an actual of 0% against a target 422 of 23%. The third rotation 430 is therefore assigned to advertiser 406.

For the fourth rotation 432, the participation levels of the highest bidding advertiser are first examined and are determined to be an actual of 33.3% against a target 418 of 40%. The fourth rotation 432 is therefore assigned to advertiser 402. This process continues with rotations 434, 436, 438 and 440 being assigned to 404, 406, 402 and 408 respectively, thereby accounting for eight rotations. A calculation at this point reveals that the actual levels for advertisers 402, 404, 406 and 408 are 37.5%, 25.0%, 25.0% and 12.5% respectively, against target levels of 40%, 27%, 23% and 10%. After numerous rotations occur the difference between the actual levels and targets levels becomes small. It is possible for all target levels to be satisfied by the associated actual levels. In this instance, the rotation can be awarded to the highest bidding advertiser.

In the bid weighted rotation, a higher bid amount results in higher placement frequency. In a pure pay for performance model, regardless of bid amount, the advertisers do not pay for the advertising impression unless the consumers receiving the ad impression respond to the advertisement. However, if the biddable ad is dynamic or interactive and includes advertiser specific content, a first fee, such as a portion of the bid amount, may be charged to the advertiser for presenting the advertisement with the full bid amount being charged to the advertiser upon the ad being responded to.

Other examination orders than that provided in the foregoing discussion can be considered so long as the method provides for substantial convergence between actual levels and target levels. Furthermore, the foregoing method for measured rotation has the advantage of providing for a priority examination order of participation levels based on bid amount.

A new advertiser may be allowed to enter a rotation that is already in progress. In this case, when a new advertiser establishes a bid, new target levels are calculated for each participating advertiser, including the new advertiser, and the new advertiser is added to the rotation. A count can be assigned to the advertiser. This count can be chosen to establish an actual participation level close to the target level of the advertiser. Alternatively, the new advertiser can assume the count of one of the advertisers adjacent to it in the order of target participation levels. If a separate total count is maintained, it is adjusted up by the count assigned to the new advertiser.

When an existing advertiser removes a bid during a rotation, new participation levels are calculated for the remaining advertisers, the advertiser removing the bid is removed from the rotation, the associated count is deleted, and if a separate total count is maintained it is adjusted down by the deleted count. When a bid changes, it can be treated as a removed bid followed by a new bid for the advertiser changing the bid.

Periodically, as the counts become large they can be scaled down. For example, when the total count exceeds 10,000 or some other predetermined threshold, all counts can be divided by 100 or some other predetermined divisor.

In the foregoing measured rotation method, the step of multiplying the participation levels by 100 percentage points to express them as percentages is not necessary, but is useful in describing the method.

As an alternative to measured rotation, a method of random rotation can also be used which applies a random number generator as a random event which is used to select the current rotation. As such, no historical counts for the participating advertisers need to be maintained by the service provider to determine rotation. The range of the random number generator is scaled to equal the range of the sum of the bids for the bidding advertisers. Each advertiser is then assigned a subset of the scaled range which is proportional to their bid amount. The advertiser occupying the subset in which the scaled random number falls is selected for the rotation. FIG. 4C illustrates a range assignment for the bid profile of FIG. 4A having a set of absolute range indications 442, 444, 446 and 448 and a set of relative range assignments 450, 452, 454 and 456 for advertisers 402, 404, 406 and 448 respectively. For a scaled random number between 1 and 40, advertiser 402 is selected and indicated by range assignment 450. For a scaled random number between 41 and 67, advertiser 404 is selected and indicated by range assignment 452. For a scaled random number between 68 and 90, advertiser 406 is selected and indicated by range assignment 454. Lastly, for a scaled random number between 91 and 100, advertiser 408 is selected and indicated by range assignment 456.

An alternate method of random rotation also uses a random number generator scaled to the sum of the bids. In this alternate method, absolute ranges of the random number generator value are assigned to the participating advertisers based on the respective bid amounts. The absolute ranges are ordered in size from largest to smallest and are subtracted one at a time from the scaled random number until the result is negative or zero. The advertiser associated with the absolute range which cause the negative or zero result is the advertiser selected for the rotation. Alternatively, the absolute ranges can be subtracted from the scaled random number until the next absolute range is larger than the remaining scaled random number. The advertiser associated with the next absolute range is the advertiser selected for rotation.

The absolute bid ranges need not be ordered and subtracted in order from largest to smallest. However this method has the benefit in that the total range for the scaled random number is traversed as rapidly as possible with each successive arithmetic operation.

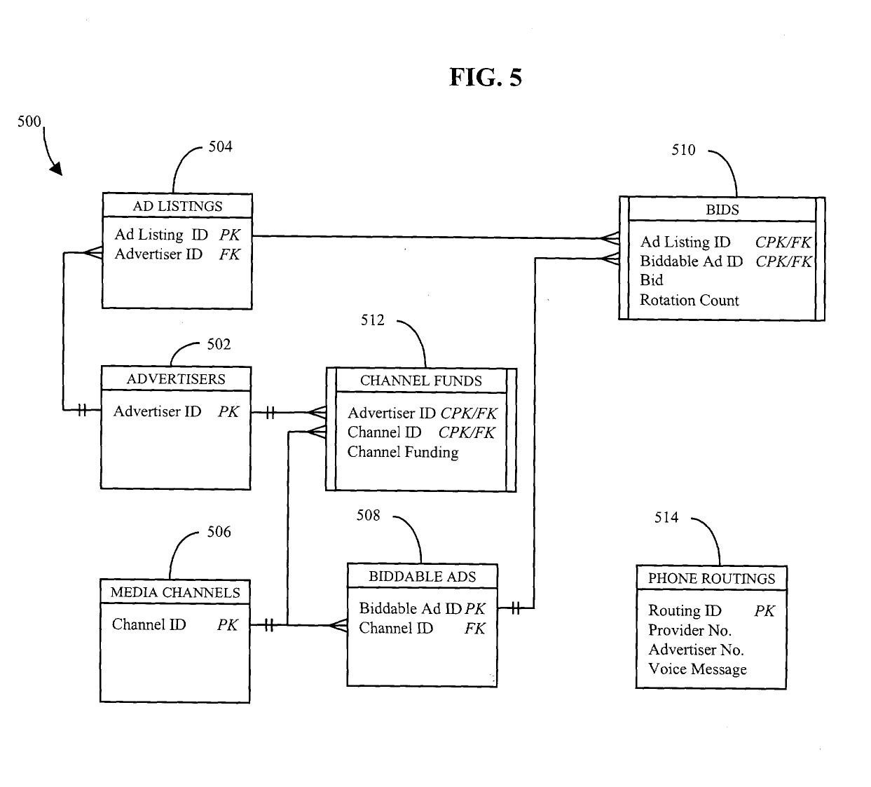

As noted in connection with FIG. 1, the service provider maintains a database 155. FIG. 5 is a pictorial diagram illustrating a suitable table structure 500 for database 155. Table structure 500 includes an advertiser's table 502, an ad listings table 504, a media channels table 506, a biddable ads table 508, a bids table 510 a channel funds table 512 and a phone routings table 514. Advertiser's table 502 comprises advertiser records which are identified by an advertiser identification (ID). Each advertiser record includes data pertaining to a given advertiser 110 and is associated with one or more ad listing records by the advertiser ID. Ad listings table 504 comprises ad listing records which are identified by an ad listing ID. Each ad listing record is associated to an advertiser 110 by an advertiser ID contained therein. The ad listings include data pertaining to a given ad listing and may contain pointers to large data files of advertising content associated with a given ad listing. Media channels table 506 include channels records which are identified by a channel ID and include data pertaining to a media channel 115 associated with the service provider 100 and is associated with one or more biddable ad records by the channel ID.

Biddable ads table 508 includes biddable ad records which are identified by a biddable ad ID. Each biddable ad record is associated with a media channel 115 by a channel ID contained therein and includes data pertaining to a given biddable ad. The biddable ad records may also contain pointers to data files of advertising content pertaining to a given biddable ad. Bids table 510 includes bid records. Each bid record is identified by an ad listing ID in conjunction with a biddable ad ID and includes a bid amount. Each bid record results in an association between an ad listing and a biddable ad having a bid placed thereon. If the biddable ad is a rotation based ad, the bid record also includes a rotation count which is associated with the ad listing and thereby is also associated to an advertiser 110.

A sub-channels table (not shown) can reside between media channels table 506 and biddable ads table 508 to enable the segmentation of media channels 115 into sub-channels. This can be used to segment a media channel 115, such as into geographic markets or specific publications. Biddable ads and bids can thereby be associated to sub-channels.

In systems where the service provider is outsourcing services to multiple channels, it may be desirable to enable advertisers to have funds associated with each channel in which they are participating. Channel funds table 512 comprises channel funding records which are identified by an advertiser ID in conjunction with a channel ID and include channel funding data. Each advertiser 110 can thereby have funds associated with one or more outsourcing channels 115.

Phone routings table 514 provides phone routing records which are identified by a phone routing ID and provide an association between a service provider phone number and an advertiser phone number. Phone routing records may also include a voice message or pointer thereto that is played in response to incoming calls to the associated service provider number. This voice message can be used to indicate to the caller the associated category for the number, such as CAR SALES, which is useful in addressing the situations where callers may be calling a number associated with an out-of-date ad. An extensions table (not shown) could be used in conjunction with phone routings table to assign multiple extensions to a given routing ID and its associated routing record and provider number. In this case the advertiser number in the routing record would be null and advertiser numbers and voice messages would be contained in the extension records of which a plurality can thereby be assigned to a given provider number.

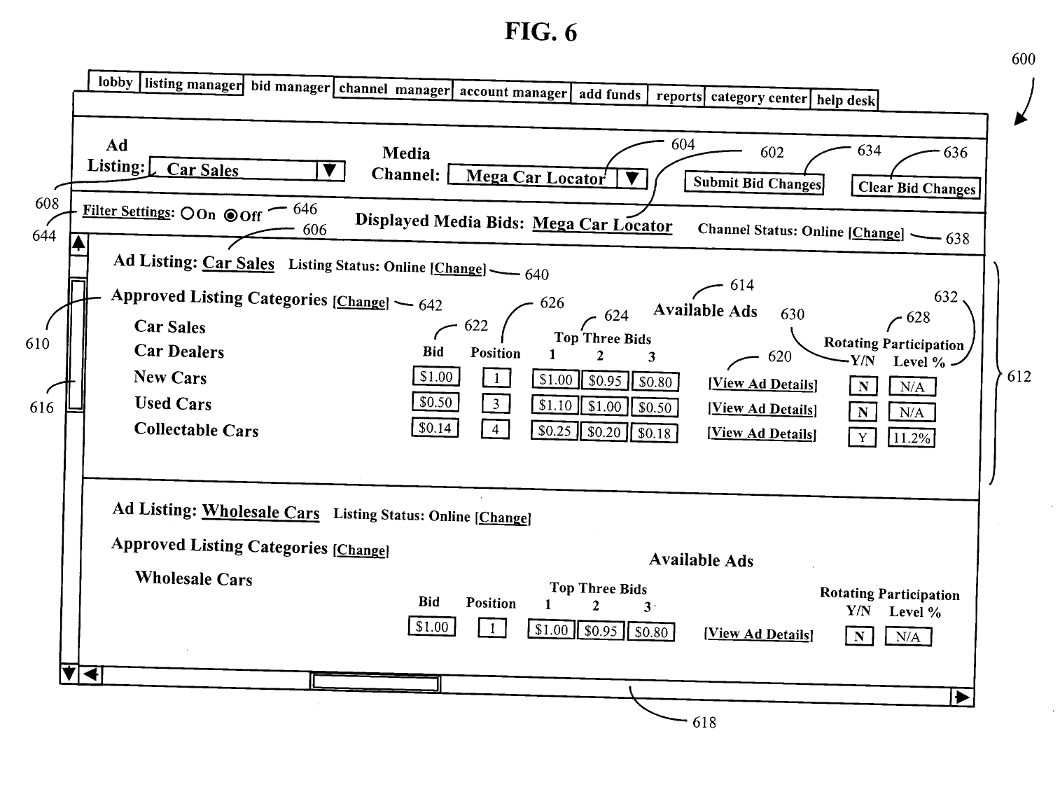

Advertiser listings can be evaluated and approved for suitability within the one or more types of general media and one or more media channels 115. The advertiser 110 can associate the listing to various biddable ads available within various media channels 115 and media types through bids placed thereon. Advertisers place bids, locate biddable ads and otherwise manage the advertiser accounts in database 155 through a bid management screen which is a graphical user interface that is presented on the advertiser computer 110. A pictorial representation of an exemplary bid management screen 600 is provided in FIG. 6. Bid management screen 600 enables an advertiser 110 to select a media channel 602 using a drop down entry box 604 and to select an ad listing 606 using a drop down entry box 608. A list of approved categories 610 associated with ad listing 606 are displayed in a section 612 of the bid management screen 600 along with access to available ads 614 for the listing, bid settings and bid information. A scroll bar 616 enables the advertiser to scroll vertically through additional listings. Alternatively, box 608 can be used to move to additional listings. A scroll bar 618 allows the advertiser to scroll horizontally through additional media channels. Alternatively box 604 can be used to move to additional channels.

A view ad details link 620 can be used to view details associated with an available ad. This can include a representation of the ad and details such as a description of fixed content, ad size, a description of the publication, location in the publication, and the like. Bids for ads can be entered in bid column 622. The advertiser can view a list of top bids 624 for available ads 614. The advertisers position relative to competitive bids for an ad is displayed in position column 626. A rotating participation section 628 has a yes/no column 630 to indicate whether the associated ad has bid weighted rotation and if so, the percentage level of participation is indicated in column 632. When a bid is entered into the ad bid location 622 for an ad that has rotation, the participation level is calculated and displayed in a participation level column 632. The bid amounts 622 for non-rotating ads represent the amount that will be charged to the high bidders account each time a consumer responds to the ad. The bid amounts 622 for rotating ads represent the amount that will be charged to the account of the current advertiser in rotation when a consumer responds to the ad.

After changes for bids within a channel are made, the advertiser can select a submit bid changes button 634 to update the channel bids. Upon selecting a clear bid changes button 636, bid changes not yet submitted for the displayed channel will be cleared and the changed bid settings are returned to their previous settings. Status change links 638 and 640 can be used to take the displayed channel 602 and displayed listing 606 offline respectively, thereby disabling associated bids. An approved listing categories change link 642 can be used to remove categories and submit new listing categories for approval. The displayed listing 606 can also be selected to access screens to remove or submit new categories. In addition, other aspects of the listing can be modified by selecting the displayed listing 606, such as modifying associated content or advertiser phone numbers.

Bid management screen 600 can also permit advertisers to filter available ads to view them by restrictions or permitted content by selecting a filter settings link 644. For example, some ads may have a restriction prohibiting mature or adult content. Some ads may not be restricted to a category. Advertisers can turn on or off filter settings using on/off settings 646.

Changes which occur too rapidly can be confusing to consumers viewing the ads. Furthermore, a response latency exists between a consumer viewing the ad and responding to it. A consumer responding to an add which has changed after viewing the ad may not be routed to the desired advertiser. Ads changing with less frequency (longer minimum times) will result in fewer instances of responses to ads which have changed. To address such concerns, minimum publication times can be specified for dynamic and interactive media to prevent excessively rapid changes in biddable ad content in response to advertiser bid changes. Another method to reduce the number of such responses to changed ads is to maintain the response mechanism, phone line, web pages, etc., for a period of time, or hold time, after the ad has changed. Minimum ad times and hold times can be included in the view ad details link 620. Prior to accepting an advertiser bid, the server can determine if the advertisers account has sufficient funds to meet an estimated response level to the add for the duration of any minimum and hold times associated with the ad.

To help insure that a response is directed to the proper ad, telecom switch 160 (FIG. 1) can provide a voice message in response to a consumer phone response to indicate the current ad or ad category associated called phone number. The telecom switch 160 can further prompt for input from the consumer to indicate if this is the desired ad category. If the consumer indicates that the current ad category is not desired, telecom switch 160 can route the call to an operator based or voice recognition based referral feature. The consumer can indicate their desired ad category and be routed to an advertiser associated with a matching category descriptor. A similar referral feature can also be implemented for responses to web page addresses. The service provider can enable bidding by advertisers on descriptors for such referrals. Advertisers can be charged their bid amount per referral. Advertisers can be associated with referral descriptors based on the highest bidder or by bid weighted rotation.

The above referral method can also be used when an funds in an advertiser account have been depleted such that they can no longer cover the associated bid amount. The consumer can be notified that the ad associated with their response is no longer active and then be provided with the referral service.

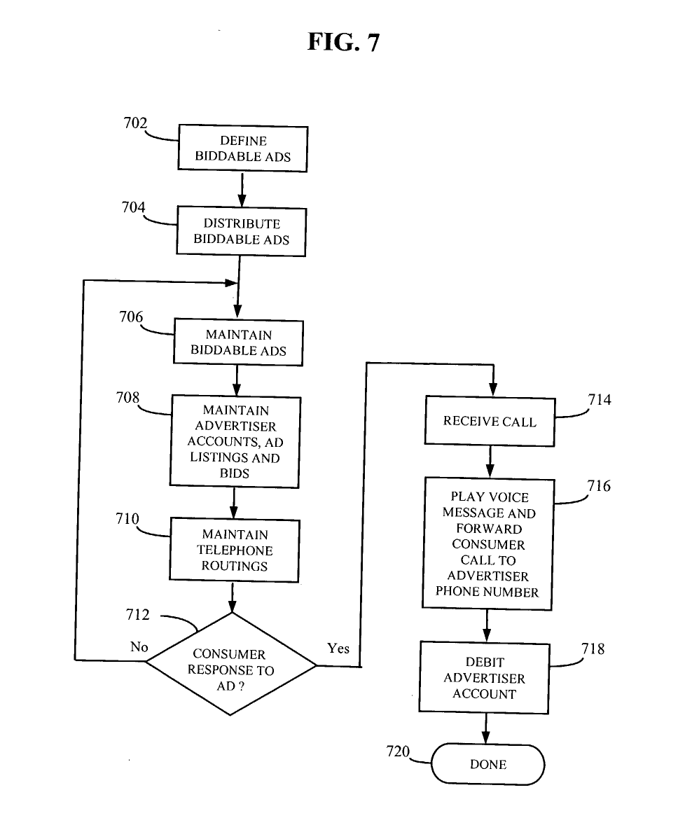

An exemplary transaction flow for a consumer response to a static media biddable ad is described in a flow diagram depicted in FIG. 7. Referring to FIG. 7, the process begins with the definition of the static biddable ads (step 702). The biddable ads can result from the service provider 100 buying blocks of ad space from a media provider 175 and defining the biddable ads or from one of the media channels 115 submitting the biddable ads for assignment of associated service provider phone numbers. The biddable ads are stored by server 140 in the biddable ads table 508 located in the database 155. The service provider 100 distributes the biddable ads to the media channel 115 or media provider 175 (step 704) through the Internet 105 for subsequent publication in static media 170. The server 140 maintains the biddable ads having associated service provider phone numbers within the database 155 (step 706). The biddable ads can be accessed by advertisers 10 through the Internet 105 for review and bidding. The server also maintains in the database 155 advertiser accounts in the advertisers table 502 and channel funds table 512, ad listings in the ad listings table 504, and bids associated with the ad listings and biddable ads in the bids table 510 (step 708). The server further maintains in database 155 telephone routings which are contained in the telephone routings table 514. The routings are based on said bids and advertiser accounts (step 710). Routings can be updated in real time due to new bids, bid changes or advertiser rotations.

If a consumer responds to an ad by calling the associated phone number contained therein (step 712), public switched telecom network 130 routes the call from consumer phone 135 to telecom switching equipment 160 which receives the call (714). Telecom equipment 160 determines the dialed number, accesses the telephone routing table 514 and forwards the consumer call to the appropriate advertiser phone 165 via the public switched telephone network 130 (step 716). Preferably, the telecom switching equipment 160 provides an audio indication of the category associated with the dialed phone number prior to routing the call. This feature can be useful when consumers call numbers associated with out-of-date print media in which the numbers are no longer valid and are in use for another category. The server 140 then debits the advertiser account contained in the advertisers table 502 and channel funds table 512 located in database 155 by the associated bid amount and for the associated channel for which the biddable ad was published (step 718), and the process terminates in step 720. If a consumer does not respond to an ad in step 712, the process returns to step 706.

Alternatively, in step 712, the consumer can respond to the biddable ad via an internet web page address. In this case, the service provider forwards the response via server 140 to a web page specified by the associated advertiser in step 716.

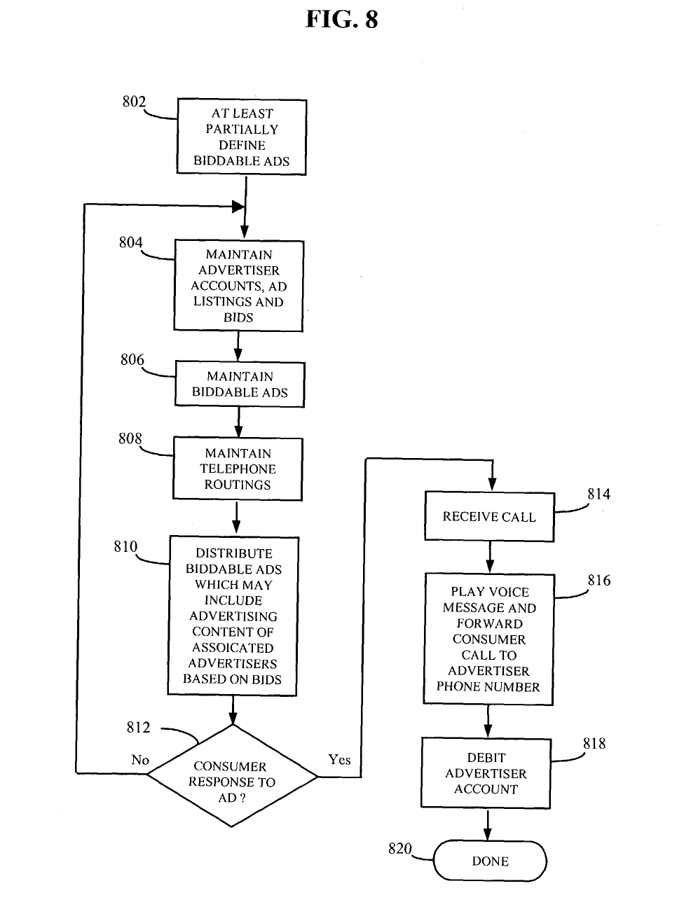

An exemplary transaction flow for a consumer response to a dynamic media biddable ad is described in a flow diagram depicted in FIG. 8. Referring to FIG. 8, the process begins with the dynamic biddable ads being at least partially defined (step 802). Ads which will include advertiser specific content which is not yet incorporated are said to be partially defined at this point in the process. The biddable ads can result from the service provider 100 buying blocks of ad space from a media provider 175 and at least partially defining the biddable ads or from one of the media channels 115 submitting the biddable ads for assignment of associated service provider phone numbers.

The biddable ads are stored by server 140 in the biddable ads table 508 located in the database 155. The server 140 maintains the biddable ads having associated service provider phone numbers within the database 155 (step 804). The biddable ads can be accessed by advertisers 110 through the Internet 105 for review and bidding. The server also maintains in the database 155 advertiser accounts in the advertisers table 502 and channel funds table 512, ad listings in the ad listings table 504, and bids associated with the ad listings and biddable ads in the bids table 510 (step 806).

Biddable ads which have advertiser specific content included therein are updated in response to new bids, bid changes or advertiser rotations. Updates are not made to biddable ads in which a minimum time requirement for a current advertiser has not yet been met. The server further maintains in database 155 telephone routings which are contained in the telephone routings table 514. The routings are based on said bids and advertiser accounts (step 808). Routings for biddable ads not having advertiser specific content can be updated and made effective in real time due to new bids, bid changes or advertiser rotations. Updated routings for biddable ads having updated advertiser specific content should be made effective in conjunction with the publication of the updated ad. Biddable ads are distributed on initial publication and in response to updated advertiser content (step 810).

If a consumer responds to an ad by calling the associated phone number contained therein (step 812), public switched telecom network 130 routes the call from consumer phone 135 to telecom switching equipment 160 which receives the call (814). Telecom equipment 160 determines the dialed number, accesses the telephone routing table 514 and forwards the consumer call to the appropriate advertiser phone 165 via the public switched telephone network 130 (step 816). Preferably the switching equipment 160 provides an audio indication of the category associated with the dialed phone number prior to routing the call. This feature can be useful when consumers call numbers associated with out-of-date print media in which the numbers are no longer valid and are in use for another category. The server 140 then debits the advertiser account contained in the advertisers table 502 and channel funds table 512 located in database 155 by the associated bid amount and for the associated channel for which the biddable ad was published (step 818), and the process terminates in step 820. If a consumer does not respond to an ad in step 812, the process returns to step 804.

Alternatively, in step 812, the consumer can respond to the biddable ad via an internet web page address. In this case, the service provider forwards the response via server 140 to a web page specified by the associated advertiser in step 816.

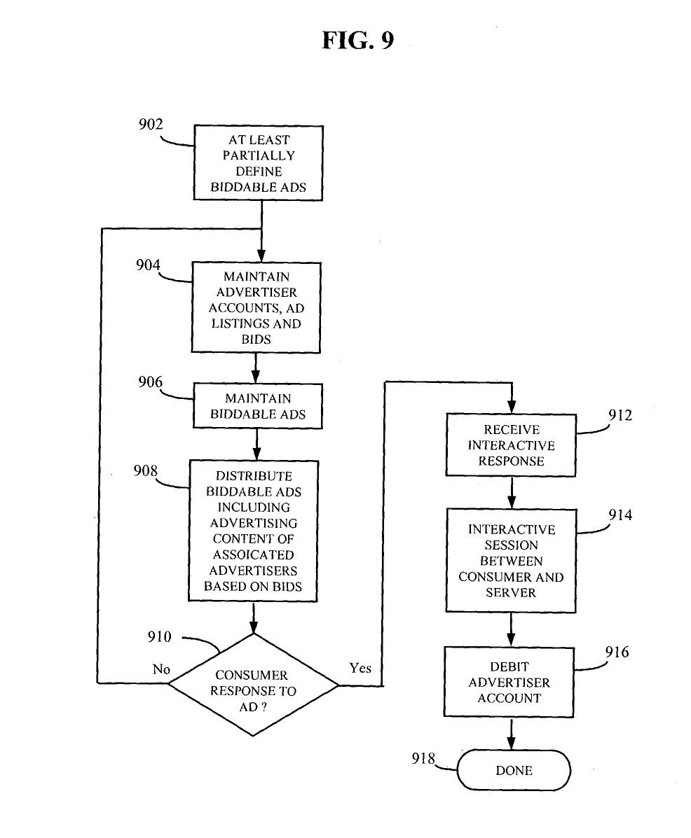

An exemplary transaction flow for a consumer response to an interactive media biddable ad is described in a flow diagram depicted in FIG. 9. Referring to FIG. 9, the process begins with the interactive biddable ads being at least partially defined (step 902). Ads in which advertiser specific content has not yet incorporated are said to be partially defined at this point in the process. The biddable ads can result from the service provider 100 buying blocks of ad space from a media provider 175 and at least partially defining the biddable ads or from one of the media channels 115 submitting the biddable ads for assignment of associated service provider phone numbers.

The biddable ads are stored by server 140 in the biddable ads table 508 located in the database 155. The server 140 maintains the biddable ads having associated service provider phone numbers within the database 155 (step 904). The biddable ads can be accessed by advertisers 110 through the Internet 105 for review and bidding. The server also maintains in the database 155 advertiser accounts in the advertisers table 502 and channel funds table 512, ad listings in the ad listings table 504, and bids associated with the ad listings and biddable ads in the bids table 510 (step 906). Biddable ads are updated in response to new bids, bid changes or advertiser rotations. Updates are not made to biddable ads in which a minimum time requirement for a current advertiser has not yet been met. Biddable ads are distributed on initial publication and in response to updated advertiser content (step 908).

If a consumer responds to an interactive ad, the service provider 100 receives the interactive response, such as via the Internet 105, from the interactive media 120 at which the consumer is located (step 914) and an interactive session between the server 140 and the consumer occurs (916). Typical interactive sessions can include a request for more information about products or services, a request for a discount coupon, directions to a retailer location and the like. Interactive sessions may also include a purchase of products or services.

The server 140 then debits the advertiser account contained in the advertisers table 502 and channel funds table 512 located in database 155 by the associated bid amount and for the associated channel for which the biddable ad was published (step 918), and the process terminates in step 920. If a consumer does not respond to an ad in step 912, the process returns to step 904.

The present invention can also be applied to biddable ads which do not have tracking mechanisms for consumer responses. For example, advertisers can bid based on attributes such as size, print quality, placement, time of day and the like, of the biddable ad, and an anticipated response level. In this embodiment, a consumer response tracking mechanism need not be employed to yield a pay for performance advertising feature.

The present invention has been described herein in connection with preferred embodiments thereof. It will be appreciated that provided the detailed disclosure herein, those skilled in the art may envision how the present invention could be practiced using alternative embodiments and variations thereof. Such variations are intended to be within the scope of the present invention which is defined by the claims appended hereto.

What is claimed:

1. A method for providing advertising services comprising:
defining at least one biddable advertisement for presentation in advertising media;
establishing a bid amount chargeable to a participating advertiser upon a response to the at least one biddable advertisement;
associating the at least one biddable advertisement with a participating advertiser based on said bid amount;
receiving responses to the biddable advertisement;
providing the responses to the associated participating advertiser; and
charging the participating advertiser associated with the biddable advertisement at the time of the response based on the bid amount.

2. The method of providing advertising services according to claim 1, wherein the advertising media is static media and the step of defining at least one biddable ad includes providing an inquiry identifier in the advertisement.

3. The method of providing advertising services according to claim 2, wherein the inquiry identifier is a telephone number of a service provider and wherein the step of associating the at least one biddable advertisement with the participating advertiser includes mapping the telephone number of the service provider with a telephone number of the participating advertiser.

4. The method of providing advertising services according to claim 3, wherein the at least one biddable advertisement comprises a plurality of biddable advertising placements arranged in static media, each of said biddable advertising placements having a unique telephone number of the service provider.

5. The method of providing advertising services according to claim 4, wherein the plurality of biddable advertising placements have differing value and the step of associating the biddable advertisement to the participating advertisers further comprises associating the plurality of advertising placements in order of value in accordance with the bid amounts of a plurality of participating advertisers.

6. The method of providing advertising services according to claim 2, wherein the inquiry identifier is a network address of a service provider and wherein the step of associating the at least one biddable advertisement with the participating advertiser includes mapping the network address of the service provider with a network address associated with the participating advertiser.

7. The method of providing advertising services according to claim 1, wherein the step of defining the at least one biddable advertisement comprises inserting content specified by the participating advertiser associated with the biddable advertisement.

8. The method of providing advertising services according to claim 7, wherein the advertising media is interactive and wherein the content specified by the participating advertiser is determined at least in part by input provided by the party responding to the biddable advertisement.

9. The method of providing advertising services according to claim 1, wherein the step of associating the at least one biddable advertisement with a participating advertiser further comprises a bid weighted rotation among a plurality of participating advertisers wherein the level of participation of each the participating advertisers is determined by the respective bid amounts.

10. The method of providing advertising services according to claim 9, wherein the bid weighted rotation associates one of the plurality of advertisers with a biddable ad based on a measured rotation of the plurality of participating advertisers.

11. The method of providing advertising services according to claim 9, wherein the bid weighted rotation associates one of the plurality of advertisers with a biddable ad based on a random rotation of the plurality of participating advertisers.

12. A method of pay for performance advertising in static media comprising:
publishing a plurality of biddable ads in static media, each of said biddable ads including an inquiry identifier therein;
providing an auction for the biddable ads among participating advertisers, wherein the participating advertisers offer bid amounts payable for responses to the biddable ads;
associating participating advertisers with said biddable ads based at least in part on said bid amounts;
maintaining a participating advertiser database, the participating advertiser database having records of advertiser accounts, advertisement listings, bid amounts associated with the advertisement listing, inquiry routing information for the participating advertisers;
receiving an inquiry from a consumer in response to at least one of the biddable ads using the inquiry identifier;
determining which participating advertiser is associated with the biddable ad being responded to and routing the inquiry using the inquiry routing information associated with the participating advertiser;
debiting the bid amount from the advertiser account of the participating advertiser to which the inquiry was routed.

13. The method of providing advertising services according to claim 12, wherein the inquiry identifier is a telephone number of a service provider and wherein the step of associating the at least one biddable advertisement with the participating advertiser includes mapping the telephone number of the service provider with a telephone number of the participating advertiser.

14. The method of providing advertising services according to claim 13, wherein the at least one biddable advertisement comprises a plurality of biddable advertising placements arranged in static media, each of said biddable advertising placements having a unique telephone number of the service provider.

15. The method of providing advertising services according to claim 14, wherein the plurality of biddable advertising placements have differing value and the step of associating the biddable advertisement to the participating advertisers further comprises associating the plurality of advertising placements in order of value in accordance with the bid amounts of a plurality of participating advertisers.

16. The method of providing advertising services according to claim 12, wherein the inquiry identifier is a network address of a service provider and wherein the step of associating the at least one biddable advertisement with the participating advertiser includes mapping the network address of the service provider with a network address associated with the participating advertiser.

17. The method of providing advertising services according to claim 12, wherein the step of associating the at least one biddable advertisement with a participating advertiser further comprises a bid weighted rotation among a plurality of participating advertisers wherein the level of participation of each the participating advertisers is determined by the respective bid amounts.

18. The method of providing advertising services according to claim 17, wherein the bid weighted rotation associates one of the plurality of advertisers with a biddable ad based on a measured rotation of the plurality of participating advertisers.

19. The method of providing advertising services according to claim 17, wherein the bid weighted rotation associates one of the plurality of advertisers with a biddable ad based on a random rotation of the plurality of participating advertisers.

20. A computer system for managing responses to advertising placements in a pay for performance advertising system comprising:
a telecom switching system, the telecom switching system having at least one telephone line for receiving response to at least one advertising placement;
a computer server, the computer server being operatively coupled to a computer network accessible by advertisers, the computer server maintaining a database in computer readable media, the database including a plurality of advertiser account listings therein, each account listing including a bid amount payable for responses to an advertising placement, response routing data, and a response record, the computer server being operatively coupled to the telecom switching system and being adapted to receive the responses therefrom and route the responses therethrough using the response routing data associated with the advertising placement being responded to.

21. A computer server for a pay for performance advertising system, the computer server comprising:
a database maintained in computer readable media, the database including a plurality of advertiser account listings therein, each account listing including a bid amount payable for responses to an advertising placement, response routing data, and a response record;
a processor, the processor being programmed to:
establish a bid amount chargeable to a participating advertiser upon a response to the at least one biddable advertisement;
associate the at least one biddable advertisement with a participating advertiser based on the established bid amount;
receive responses to the biddable advertisement;
provide the responses to the associated participating advertiser in accordance with the response routing data in the database; and
updating the response record of the associated participating advertiser at the time of the response in accordance with the bid amount.

22. The computer server of claim 21, wherein the processor operations for establishing a bid amount further comprise performing an auction for the biddable advertisement among a plurality of advertisers.

23. The computer server according to claim 21, wherein the processor operations for associating the at least one biddable advertisement with a participating advertiser further comprise a bid weighted rotation among a plurality of participating advertisers wherein the level of participation of each the participating advertisers is determined by the respective bid amounts.

24. The computer server according to claim 23, wherein the bid weighted rotation associates one of the plurality of advertisers with a biddable ad based on a measured rotation of the plurality of participating advertisers.

25. The computer server according to claim 23, wherein the bid weighted rotation associates one of the plurality of advertisers with a biddable ad based on a random rotation of the plurality of participating advertisers.
